(19) United States
(12) Patent Application Publication
(10) Pub. No.: US 2026/0268761 A1
(43) Pub. Date: Sep. 10, 2026

(54) WARNING SYSTEM FOR VEHICLES APPROACHING A VISUAL OBSTRUCTION

(71) Applicant: John Schultz, Bonny Doon, CA (US)

(72) Inventor: John Schultz, Bonny Doon, CA (US)

(21) Appl. No.: 19/555,852

(22) Filed: Mar. 3, 2026

Related U.S. Application Data
(60) Provisional application No. 63/767,293, filed on Mar. 5, 2025.

(51) Int. Cl. G08G 1/01; G08G 1/04; G08G 1/052; G08G 1/0967

(52) U.S. Cl. CPC G08G 1/0116; G08G 1/04; G08G 1/052; G08G 1/096783

(57) ABSTRACT

A system, and method of use, comprising an observer system and a beacon. The observer is installed proximate to a visual obstruction within a travel pathway; the obstruction, such as, but not limited to, may comprise a blind curve, a blind spot, a dip, a rise having a distal decline on a pathway, and fog and smog. The speed of the beacon, as derived from two identification signals of increasing intensity, determines aspects of a sensory signal generated by the observer. The observer generates a sensory warning for a set duration and type that is partly based upon the identification signals. The beacon may be set to emit for only a set duration. The beacon may identify its carrier by a type or name, such a person, a bicycle, a motorcycle an automobile, a truck, a bus, or other vehicle or mode of transportation.

### CROSS-REFERENCE TO RELATED APPLICATIONS

This Nonprovisional patent application is a Continuation-in-Part of Provisional Patent Application Ser. No. 63/767,293 as filed on Mar. 5, 2026, by Applicant of the present disclosure. Provisional Patent Application Ser. No. 63/767,293 titled “Roadside Warning Signal for Safely Navigating a Blind Curve” is hereby incorporated into its entirety and for all purposes into the present disclosure.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The present disclosure incorporates by reference the following publications, patents, and/or patent applications, in their entirety and for all purposes: U.S. Pat. No. 12,184,327, issued to Inventor Solanki; Deepak on 2024 Dec. 31, and titled Optical Wireless Communication System And Adaptive Optical Wireless Communication Network; U.S. Pat. No. 7,924,149 issued on Apr. 12, 2011 (Inventor: Ehud Mendelson) and titled SYSTEM AND METHOD FOR PROVIDING ALARMING NOTIFICATION AND REAL-TIME, CRITICAL EMERGENCY INFORMATION TO OCCUPANTS IN A BUILDING OR EMERGENCY DESIGNED AREA AND EVACUATION GUIDANCE SYSTEM TO AND IN THE EMERGENCY EXIT ROUTE; PCT Patent Application Publication No. WO2020096060A1 (Application Ser. No. PCT/JP2019/044003) published on May 14, 2020 (Assignee Iomap LLC) and titled “Motorcycle and motorcycle lighting device”; Republic of Korea Patent Application Publication No. KR20100028270A, published on 2010 Mar. 12 and titled “Walker traffic accident preventing apparatus”; PCT Patent Application Publication Ser. No. WO2025187865A8 published on 2025 Oct. 2 and titled “Traffic sign using leds”; and US Patent Publication Ser. No. US20130181849A1, published on 2013 Jul. 18 and titled Luminous traffic sign plate with speed detecting and warning function”.

The above-cited publications, patents, and/or patent applications are incorporated herein by reference in their entirety and for all purposes.

### BACKGROUND OF THE INVENTION

### Field of the Invention

The present invention is generally related to a method and system for scanning for the presence of a broadcasting beacon signal sufficient to trigger a corresponding sensory warning transmission. The present invented method is more particularly related to mobility safety, and to methods and systems for avoiding incidents of panic, and collision between vehicles, persons and obstructions, including but not limited to, human beings, bicycles, motorcycles, boats, automobiles, autobuses, trucks, slow moving vehicles, obstructions and other entities and vehicles.

### Background of the Invention

The subject matter discussed in the background section should not be assumed to be prior art merely on the basis of having been mentioned in the background section. Similarly, a problem mentioned in the background section or associated with the subject matter of the background section should not be assumed to have been previously recognized in the prior art. The subject matter in the background section merely represents different approaches, which in and of themselves may also be inventions, and provides additional context.

Persistent visual obstructions are present in relation to a direction of travel along a pathway, such as a paved road, a unpaved path or waterway, and other well, or seldom, travelled passageways. Dips in a pathway, rises in a pathway, curves that obstruct a point or a length of a pathway positioned ahead of a vehicle can increase the risk of said vehicle colliding with a person or other vehicle, or of an operator of said vehicle, or suddenly observes vehicle a person when said operator. vehicle a person

Systems exist that provide enhanced visual communications systems for vehicles that are in distressed, breakdown, or emergency states. Enhanced visual communications systems may also be deployed when a vehicle has had an airbag activation or activation of traction control, ABS, or a similar automatic safety system. Enhanced visual communications systems may rely on increased flash rates (e.g., strobing) of vehicle signal lights or other lights that may include auxiliary lights or remote beacons. Various flashing patterns may be utilized in a manner designed to attract attention or communicate more effectively than with older slow speed standard hazard flasher systems. Examples of such enhanced visual communication systems relying on utilizing vehicle signal lamps are described in U.S. Pat. No. 9,481,331 to Tucker et al. and U.S. Pat. No. 9,616,810 to Tucker et al.

Although enhanced visual communication systems relying only on strobing lights or other visual enhancements serve well to inform vehicular drivers in proximity to a vehicle or person, and that caution should be exercised when approaching, they are necessarily limited in their ability to inform drivers who may be too far away, behind other vehicles, around curves or bends in the road, or inhibited by other obstructions. Enhanced visual communication systems also still rely on at least some amount of attention being paid by other drivers, as well as their reaction time and ability to properly sense, assess an person or vehicle on the road ahead, and to react appropriately. Hearing impaired drivers may particularly need visible warning signals. Moreover, it would remain up to the individual driver to know how and when to avoid person or vehicle present in their forward direction of travel. It will occasionally be observed that a driver will activate his or her emergency flashers upon encountering another vehicle at risk or another emergency situation in order to pre-emptively alert drivers behind or near him or her. Although helpful, this is far from universal. Additionally, mere activation of hazard lights cannot provide information to drivers who are out of sight of the original event and do not know what is happening or how to respond. For example, in some cases it would be entirely appropriate to continue with increased caution, e.g., poorly steered bicycles, moving animals near or on a pathway.

There is, therefore, a long-felt need for an improved, effective, and accessible warning system and method that provides a sensory warning to a driver of a vehicle (or a warning to an autonomous vehicle system) of entities and vehicles in a same pathway of the vehicle that are momentarily or temporarily visually obstructed from the viewpoint of the vehicle.

### BRIEF SUMMARY OF THE INVENTION

Towards these and other carriers of the method of the present invention (hereinafter, “the invented method”) that are made obvious to one of ordinary skill in the art in light of the present disclosure, the invented method provides a system (hereinafter, “the invented system”) comprising a beacon and a temporary or permanent detection system (hereinafter, “the observer”) positioned between and oncoming direction of travel and a visual obstruction; when the observer detects a designated signal from the beacon, and the observer generates a sensory and/or a wirelessly transmitted signal for a set duration after the beacon emitting the detected signal has been detected. The observer preferably emits a sensory warning for approaching vehicles that a vehicle or entity of concern residing in the direction of travel is concealed by a visual obstruction.

The observer may be placed in advance of an area in a roadway with limited or no forward line-of-sight, e.g., a blind turn or a blind summit, and detects the presence of a recognizable beacon transmission that causes the beacon to emit a sensory warning for a set time indicating to others following the beacon that there is an active “hazard” ahead.

Certain alternate preferred embodiments of the invented method employ Bluetooth Low Power (BLE) technology. BLE beacons and observing circuits are common power-efficient, short-range wireless personal area network technology designed for IoT, wearables, and medical devices to operate for months or years on small batteries. These alternate preferred embodiments of the invented method leverage a core BLE feature called “advertising” that allows BLE devices to broadcast information without the need for pairing or a connection. BLE advertising is a mechanism where a device sends out small packets of data at regular intervals to announce its presence. This information can be picked up by a nearby BLE communications-capable observer in accordance with certain aspects of alternate embodiments of the present invention. A BLE observer passively scans for and receives advertising packets from broadcasters. Observers do not initiate connections or send data back, enabling one-way, low-power communication which is ideal for this implementation using beacons or a phone app as the end user event triggering device.

The BLE-complaint beacon can be any device that can be programmed to advertise a specific device name within its raw advertisement data stream, like common BLE beacons and cell phones. Observers of various alternate preferred embodiments of the invented method can be any device that can routinely scan for the presence of a BLE broadcast device, process the raw advertised data, specifically looking for a device name, and react to the presence of a known device name by triggering a warning event. That warning event may be visual or auditory and resets after a defined period.

A first alternate embodiment of the invented system provides approaching carrier warnings, and includes a beacon and an observer. The beacon is carried by in an carrier, such as a person or a vehicle. As the beacon preferably stores an encoded identification, and includes and a wireless signal emitter, a beacon power source. The signal emitter broadcasts encoded identification in an identification signal. The observer is preferably located or installed proximate to a line-of-sight obstruction on the pathway, and an expected direction of travel along the pathway of the carrier and the beacon.

The observer includes a signal light that may include an LED that is electrically coupled with a power source via a controllable on/off switch. The observer power source may a rechargeable battery, replaceable battery, a solar power cell, and/or connection to a power grid; the observer power source is preferably electrically coupled to and provides electrical power to the signal sensor, the source of encoded instructions (a memory”), and the logic device, e.g., a controller, a micro controller, a configured or programmed logic circuit, a reconfigurable or reprogrammable logic circuit. The logic device is communicatively coupled with the memory and the controllable switch, the encoded instructions directing the logic device to perform one or more of the following options: (a.) derive a speed of the carrier by comparing the signal energy levels a pair of information signals received from the beacon, and a delta of time of reception of the pair of information signals; (b.) determine whether the beacon is moving no faster than a predetermined speed parameter by a magnitude of difference of the energy signals divided by the delta of time of reception; (c.) when the logic device determines that speed is no faster than the predetermined speed parameter, electrically powering illumination of the signal light for a preset duration by directing the on/off switch to enable an electrical current to flow from the power source and to the signal light; and (d.) when the signal light has been illuminated for the preset direction, return the observer to a rest state, whereby an electrical power flow through the controllable switch and the power source to the signal light is inhibited. The signal emitter and the signal sensor are preferably selected to enable detection of the identification signal by the signal sensor at no more than 20, or more preferably at no more than 8 meters. The carrier carrying the beacon may be a person, an animal, a vehicle, a bicycle, a motorized bicycle, an automobile, a truck, or a boat. The beacon is optionally detachably coupled to the carrier. The beacon is optionally comprised within a portable electronic device, such as, but not limited to, a cellular telephone or a portable computational device.

Additional alternate preferred embodiments of the invented system include a second beacon coupled with a second carrier, wherein the second beacon emits a second and distinguishable identification signal, and the observer detects the second identification signal, and might thereupon reinitiates an illumination duration, whereby the period of time of illumination of the signal light is reset. The observer's instructions may be additionally configured to direct the processor to illuminate the signal light for an alternate period of time when the second signal is detected by the signal sensor. The beacon optionally incudes comprises an enable/disable control coupled with the wireless signal emitter and the beacon power source, and whereby when the enable/disable control is set to enable by a user the signal emitter receives electrical power from the beacon power source and thereupon broadcasts the identification signal. The beacon further optionally includes a countdown timer coupled with the enable/disable control and the beacon power source, whereby the countdown timer is initiated when the enable/disable control is set to enable, and the enable/disable control is set to disable when the countdown timer times out, whereby the signal emitter ceases broadcasting the identification signal.

A line-of-sight obstruction addressed by the invented method may include a bend in a pathway, a decrease in elevation of a pathway, an increase and subsequent decline of a pathway, vegetation, a sign, a bridge crossing over the pathway, a volume of atmospheric fog, a volume of atmospheric smog, and/or a geologic feature.

Additional alternate preferred embodiments of the invented system include an identification signal includes a name datum identifying a name of an carrier; and a plurality of identifying lights, each light of the plurality of lights visually rendering a unique and visually distinguishable icon when powered, wherein the encoded instructions are additionally configured to direct the processor to associate each identifying light with at least one name datum, and enable power delivery to illuminate the associated identifying light that is associated with the identification signal name datum.

Yet additional alternate embodiments of the invented method include one or more of the following aspects of (1.) installing proximate to a blind curve a roadside signaling device which emits a signaling light when the device detects proximity of a beacon and continues to emit the signaling light for a preset duration of time thereafter; (2.) equipping one or more slow-moving vehicles which traverse the blind curve with instances of the detectable beacon; (3) equipping one or more vehicles which traverse the pathway and are temporarily obstructed from view with additional instances of the detectable beacon; (4.) the roadside signaling device is configured to determine a speed of the beacon in derivation from two succeeding identification signals, whereby the difference in energy levels of the two succeeding identification signals and the time differences of reception of the two succeeding identification signals; and (5.) if and only if the determined speed if the beacon is less than or equal to a preset speed parameter, empowering the signaling device to emits the signaling light preset duration of time.

The observer is preferably located along an expected pathway or direction of travel from which both the beacon and approaching vehicles are expected to traverse en route to and in passing by or through the visual obstruction. The visual obstruction may be a geological feature and/or a manmade structure, a dip or rise of the expected, a blind spot or a blind curve located relative to the expected pathway, an anticipated or detected fog or smog, and/or other suitable visual obstructions to travel known in the art.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWING(S)

The detailed description of some embodiments of the invention is made below with reference to the accompanying figures, wherein like numerals represent corresponding parts of the figures.

FIG. 1 presents a winding road with visual obstructions and a first preferred embodiment of the invented system;

FIG. 2 presents a block diagram of one version of a Beacon of FIG. 1;

FIG. 3 is a block diagram of one version of the Observer of FIG. 1.

FIG. 4 is a flowchart of a flowchart of the operations of the Beacon of FIGS. 1 and 2

FIG. 5 is a block diagram an example of a frame format of the Beacon signal;

FIG. 6 is a block diagram of the header element of the frame format of FIG. 5.

FIG. 7 is a flowchart of the operation of the Observer of FIGS. 1 and 3;

FIG. 8 is a flowchart of the additional operations of the is a flowchart of the operation of the Observer of FIGS. 1, 3 and 7; and

FIG. 9 is an exemplary Observer's Look up Table accessed at in FIGS. 7 and 8

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

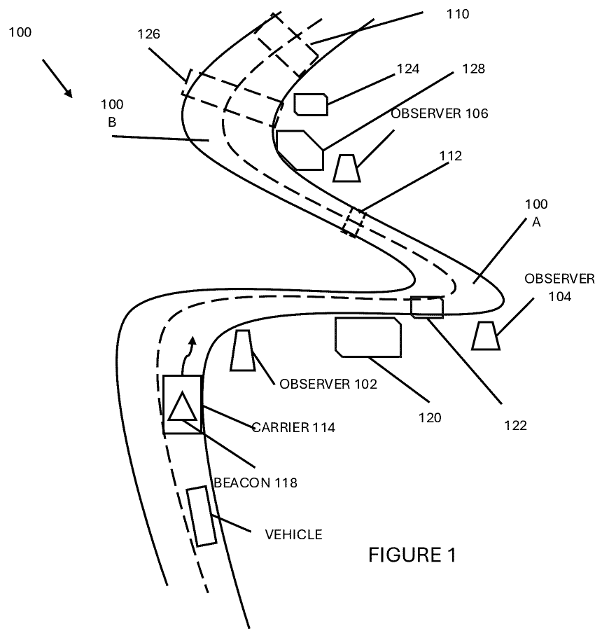

Referring now generally to the Figures, and particularly to FIG. 1, FIG. 1 presents a winding road 100 with three observers 102, 104, & 106, and includes a feature of the road 100, such as, but not limited to, a curve 108, a dip 110 of the road 100, or a rise 112 of the road 100 that causes a visual obstruction that might temporarily, and partially or fully, impede the visibility of a carrier 114 to driver (not shown) of a faster moving vehicle 116, i.e., the trailing and approaching vehicle 116. The carrier 114 is coupled with or has onboard a portable wireless communications-enabled beacon 118 (hereinafter, “the beacon” 118). The carrier 114 and the vehicle 116 are preferably travelling in a same directional flow of traffic and on a same side 100A of the road 100. Additional visual obstructions that might partially or fully impede an immediate line-of-sight visibility of the carrier 114 from the point of view of the driver include, but are not limited to, vegetation 120, a construction or engineering equipment 122, a buildings 124, a bridge traversing 126 the road 100, and a geologic feature 128, or combination thereof.

It is understood that the range of meaning of the term “coupled with” as used in the present disclosure includes the adjectival phrase of attached to, detachably attached to, affixed to, upon or within, located on or within, and coupled with. that the range of meaning of the term “pathway” as used in the present disclosure includes roads, paths, and routes.

In a first preferred method of the present invention (“the first method”) the beacon 118 coupled with the carrier 114 passes by one or more observers 102, 104 & 106 before the vehicle 116. For the sake of clarity of explanation, in the present disclosure the first observer 102 may be addressed as representing itself as well as with each other observers 104 & 106 whereas the beacon 118 may interact with the in similar and/or with the same processes, steps and aspects with the other two observers 104 & 106.

The observer 102 is preferably sited closer to the same side 100A of the road 100 than to a distal side of the road 100B. Proximity detection of the beacon 118 in a passing of the carrier 114 by one or more observers 102, 104 & 106 causes each detecting observer 102, 104 & 106 to determine whether or not to generate a sensory signal to inform the driver of the vehicle 116 of a presence of the carrier 114 on the road 100, wherein the observer attempts to warn the driver of the vehicle 116 the carrier 114 is possibly not visually ascertainable, due to a visual obstruction 108, 110, 112, 120-28,

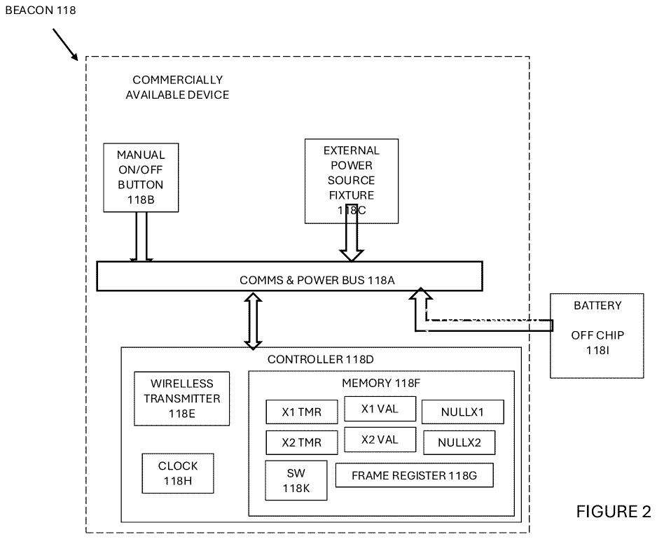

Referring now generally to the Figures, and particularly to FIG. 2, FIG. 2 presents a block diagram of the beacon 118. Suitable wireless communications beacons having the functionalities described as required in the present disclosure are well known in the art. These suitable prior art beacons include beacons using the wireless communications standards and modalities including, but not limited to the Bluetooth Low Energy (BLE) is a wireless communication standard; the Zigbee IEEE 802.15.4-based specification for communication protocols; the wifi-6, IEEE 802.11ax-2021, also known as or 802.11ax, IEEE standard from the Wi-Fi Alliance, for wireless networks (WLANs); the THREAD, IPv6-based, low-power mesh networking protocol designed for Internet of Things (IoT) devices; the MATTER a smart home connectivity standard, and/or other suitable wireless communications standards and modalities

The beacon 118 comprises a communications and power bus 118A an optional manual on/off button 118B, an external power source fixture 118C, and a controller 118D. The controller 118D includes a wireless transmitter 118E, a beacon memory 118F comprising a frame register 118G, and a real time clock 118H. Software encoded beacon instructions SW 118I stored in the beacon memory 118F direct the wireless transmitter 118E to broadcast the contents of the frame register 118G within a duty cycle period X1 and in accordance with a preconfigured duration of time X2. The real time clock 118H generates timing pulses that enable the configured logic 118D to conform with and maintain the duty cycle period time value X1 and in accordance with a preconfigured duration of time value X2. The value duty cycle time period value X1 is on the order of milliseconds and the preconfigured duration of time value X2 is typically in the order of minutes. For example, the beacon 118 might store and apply exemplary values of 20 milliseconds per duty cycle X1 and the duration of time value X2 might be on the order of 30 minutes, e.g., the estimate for a slow bicyclist to bicycle up a slope and power well beyond a selected visual obstruction 108, 110, 112, 120-28 of FIG. 1.

When the beacon manual on/off button 118A is depressed, a duty cycle timer X1 is (re)initialized to the duty cycle period time value X1 and a duration timer X2 is (re)initialized to preconfigured duration of time value X2. The duty cycle timer X1 and the duration timer X2 are then adjusted toward appropriate separate null values by the process of counting clock cycles received from the real time clock 118G towards each timer's null values. When the duty cycle timer X1 reaches an X1 duty cycle null value, it is reset by the controller 118D to the duty cycle period time value X1; whereas when the duration timer X2 reaches an X2 duration null value, the beacon 118 ceases transmitting the contents of the frame register 118G, leaves and or resets the duty cycle timer X1 to the duty cycle null value and leaves the duration timer X2 reaches at the duration null value. The duty cycle null value NULLX1, the duty cycle timer X1, the duration time value X2, the duration time null value NULLX2, the duration timer X2, and the duration timer X2 are maintained within the on-chip memory 118F.

A replaceable off-chip battery 118J supplies electrical power via the communications and power bus 118A to the controller 118D, the wireless transmitter 118E, the memory 118F, and the real time clock 118H. Optionally, alternatively, or additionally, the external power source fixture 118C may be electrically connected to an external power source (not shown) and provides electrical power via the communications and power bus 118A to the controller 118D, the wireless transmitter 116E, the frame register 118F, and the real time clock 118G.

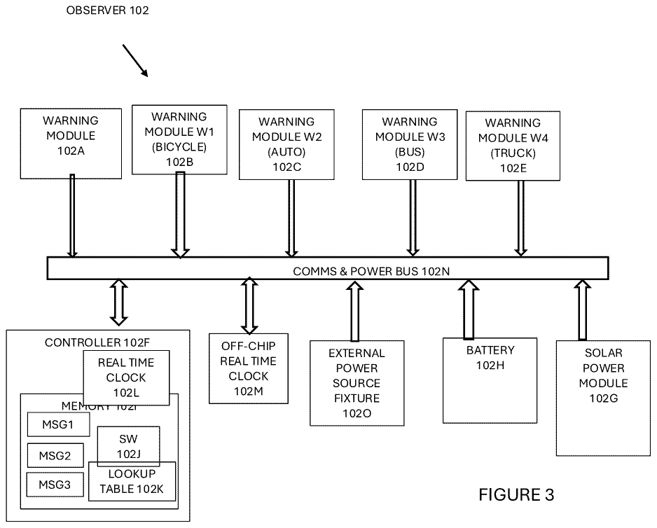

In certain yet alternate preferred embodiments that employ BLE methods and devices, in an advertising state, the BLE-compliant beacon transmits packets containing useful data for the observer 102 to receive and process. The packets are sent at a fixed interval defined as the Advertising Interval, i.e., duty cycle period X1. The raw advertising data contains a NAME of the carrier type that is known by the Observer. It is understood that some or all of the circuitry of the beacon 118 can be purchased as elements of, individual components or in combinations in commercially available products, such as (1.) a Mini Bluetooth Beacon™ with a pushbutton on/off button, as marketed by GAOTek, Inc., of New York City, New York, (2.) an iPhone 17™ cellular telephone as marketed by Apple, Inc. of Cupertino, CA, or (3.) an AirTag™ tracking device as marketed by Apple, Inc. of Cupertino, CA. It is understood that the AirTag™ tracking device does not include a NAME as discussed in reference to aspects of the invented method disclosed regarding FIGS. 3 through 8.

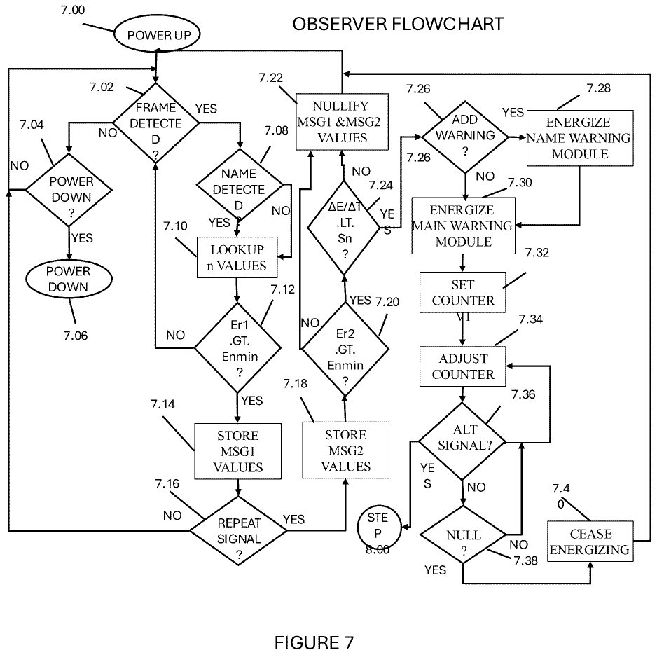

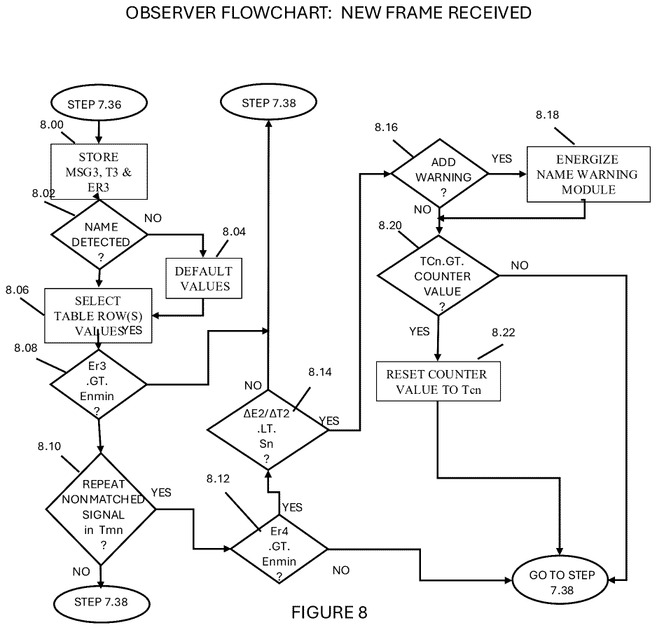

FIG. 3 is a block diagram of the first observer 102 having a main warning module 102A, optional name specific warning modules 102B-102E, a controller 102F, an optional solar power module 102G, and an internal battery 102H. It is understood that the observer 102, 104 & 106 will each be configured and adapted to be compatible to receive wireless transmissions from the beacon 118. The observer controller 102F comprises a memory 102I that stores an encoded software SW 102J and a lookup table 102K, wherein the software SW 102J and a lookup table 102K enables and directs the controller 102 to perform the aspects and actions of the operations of the flowcharts of FIGS. 7 & 8 in view of the information and energy levels received from the beacon 118, and pulses received from a controller's on-chip real time clock 102L and/or from an off chip external real time clock 102M. Incoming signal and message data MSG1 & MSG2 is stored in the observer memory as will be explained in accompanying text to FIGS. 7 and 8.

A communications and power bus 102N receives electrical power from the (a.) battery 102H, (b.) the optional solar power module 102G, and/or (c.) an external power source (not shown) via an optional external power source fixture 1020, and distributes the received power to the observer controller 102F and as directed by the observer controller 102F, to (a.) the main warning module 102A, (b.) the W1 bicycle warning module 102B, (c.) the W2 automobile warning module 102C, (d.) the W3 warning module 102D.

In certain yet alternate preferred embodiments that employ BLE methods and devices, wherein the beacon 118 sends out small packets of data at regular intervals to announce its presence. The observer 102 scans at regular intervals for the presence of a BLE advertisement. If the observer 102 detects an advertisement, the signal strength of the Beacon messaging is tested to be within predefined limits. The limits are defined to approximate distance. If within limits the raw data is searched for a NAME. If the NAME matches one in the table 102K, the device signal strength again is tested to approximate speed based on change in signal strength and scan delay. If within speed limits as related to the NAME via the table 102K, established to the observer 102 by a matching NAME of the table 102K, a warning event timer is set to a time noted in the table 102, and the one or more additional timers of related warning modules are energized for times specified as related in the table 1020. The time duration timer is also reset if there are other advertisements that may reset the count of the time duration timer. For example, if there are a group of cyclists, the warning time duration would be reset to reflect the last of a current warning time duration, rather than just counting to decrease the time allotted by the first and earlier detected NAME.

The elements shown within the commercially available device outline can be purchased as one or more unified modules, such as (1.) an ESP32-C6™ as marketed by Espressif of Shanghai, China; (2.) ISP140501 an autonomous low-power device for wireless detection and transmission as marketed by InsightsIP, LLC of CARY, NC, or other suitable wireless beacon detection known in the art and selected for compatibility with the beacon 118.

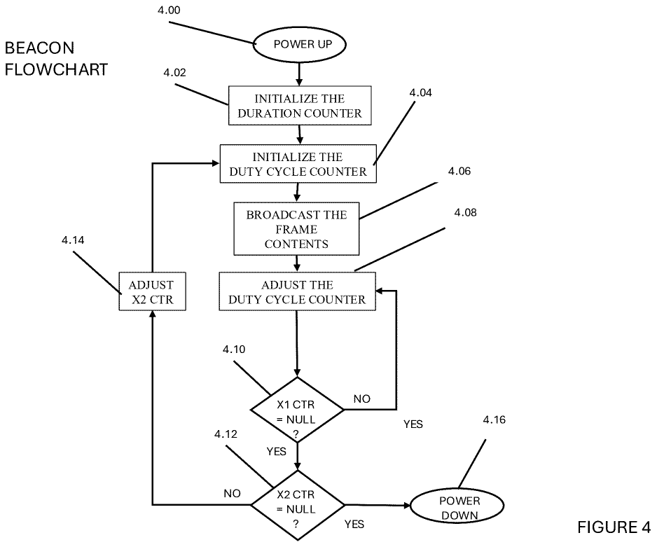

FIG. 4 is a flowchart of the operations of the beacon 118 as directed by the beacon controller 118D and in accordance with the beacon software SW 118K. The beacon 118 is powered up in step 4.00 in reaction to the controller 118D receiving turn-on signal generated by the on/off button 118B. It is understood that the turn-on signal of step 4.00 might alternately be received by wireless communication circuitry (not shown). In step 4.02 the duration time counter X2 is initialized. In step 4.04 the duty cycle counter x1 is initialized. In step 4.06 the beacon 118 broadcasts the contents of the frame register 118G. In step 4.08 the duty cycle counter X1 is adjusted towards the duty cycle null value. In step 4.10 the X1 counter value is compared with the duty cycle null value, and if X1 counter value does not equal or exceed the duty cycle null value, the process FIG. 4 returns to another execution of step 4.08 to adjust the duty cycle counter further towards the duty cycle null value. When the X1 duty cycle counter value is determined in step 4.10, to equal or exceed the duty cycle null value, the process of FIG. 4 proceeds on to step 4.12 to determine if the X2 duration counter value equals or exceeds the duration null value. When the in step 4.12 the X2 duration counter value is not determined to equals or exceeds the duration null value, the process of FIG. 4 proceeds onto step 14.14 and the adjust the value of the duration counter X2 toward the duration null value, and therefrom to an additional execution of step 4.04. In the alternative, when the X2 duration counter value is determined in step 4.12 to equal or exceed the duration null value, the process of FIG. 4 proceeds from step 4.12 to step 4.16 and to power down and cease broadcast the contents of the frame register 118G.

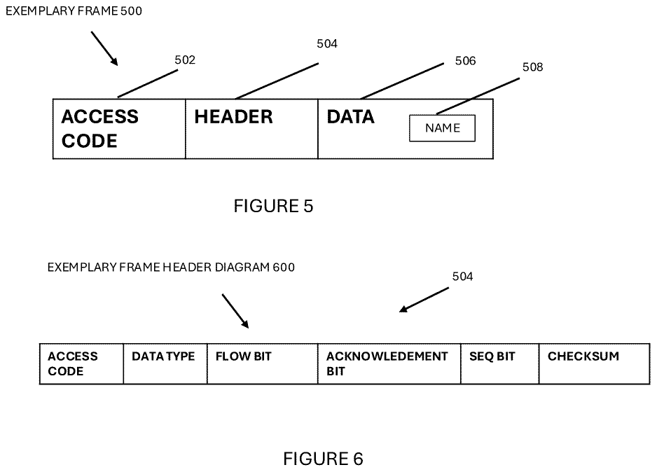

FIG. 5 is a block diagram an example of a bluetooth frame 500 stored within the frame register 118G of the beacon 118, the frame 500 having an access code 502, a header 504 and a data field 506. A NAME 508 associated with the carrier 114 transporting the beacon 118, i.e., an identifier of a vehicle type of the carrier 114, is contained in the data field 506 of the frame 500. The data field 506 can be 0 to 2744 bits long.

FIG. 6 is an exemplary bluetooth format diagram 600 of the header 504 of the bluetooth frame The header 504 contains following subfields:
(1). Header Address: this 3 bit field can define up to seven slaves (1 to 7), and if the address is zero, it is used for broadcast communication from primary to all secondaries;
(2.) Type: this 4 bit field identifies the type of data coming from upper layers;
(3.) Flow bit F: this flow bit is used for flow control, and when set to 1, the flow bit indicates that means the frame 500 is unable to receive more frames;
(4.) Acknowledgement bit is used for messaging acknowledgement;
(5.) S but: this bit contains a sequence number of the frame to detect retransmission, and when a stop and wait protocol is used, one bit is sufficient;
(6.) Checksum: the checksum 8 bit field contains checksum to detect errors in header. As mentioned in reference to FIG. 5, data field 506 can be 0 to 2744 bits long, and it may contain data or control information coming from upper layers

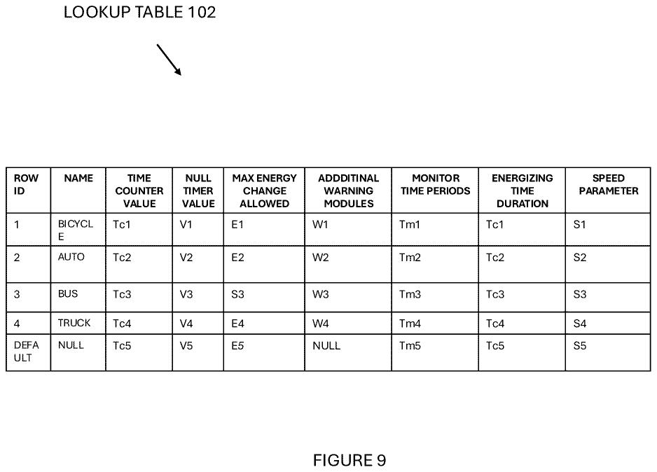

FIG. 7 is a flowchart of the operation of the exemplary observer 102, wherein one or more NAME rows R1-R4 (and/or a default row R5) are looked up from the table of FIG. 9. The process of FIG. 7 is driven by the observer controller 102F as directed by the observer software 102J. In step 7.00 the observer 102 proceeds onto step 7.02 to determine whether a frame 500 or other wireless message has been received. When the observer 102 does not determine in 7.02 or that a frame 500 or other wireless message has been received, the observer software 102J directs the observer controller 102F to execute step 7.04 and determine whether to power down, and when the observer software 102J directs the observer controller 102F to power down the observer 102, the observer 102 proceeds from step 7.04 to step 7.06. When the observer controller observer controller 102F determines in step 7.04 to not power down, the observer 102 proceeds back to another iteration of step 7.02.

In the alternative, when the observer controller 102F determines that a frame 500 or another wireless communication, e.g., an AirTag signal, has been detected in step 7.02, the observer controller 102F records the current message content MSG1, a time if T1 of receipt of the message, and the level of the received energy intensity level Er1 of the current message content MSG1 in the observer memory 102I, and the moves on to step 7.08 and to query the received current message content MSG1 for a NAME. If no NAME is read from the message in step 7.08, the observer controller 102F reads a set of default values of a default row 5 from a default value row R5 lookup table 102K of FIG. 9; in the alternative if the observer controller 102F has read a NAME from the message detected in step 7.02, the observer controller 102F proceeds to access a lookup access row R1-R4 n associated with the NAME from the lookup table 102K of FIG. 9, wherein “n” represents one of the NAME rows R1 through R4 and a default row R5, wherein each row R1-R4 is associated with a particular NAME, and the default row R5 is applied when the observer 102 cannot read a NAME from the signal received in step 7.02.

In the alternative, when the observer controller 102F determines in step 7.12 that the received energy intensity level Er1 is greater than the minimum required energy intensity level Enmin, the observer 102 proceeds onto step 7.14 and accesses the values of the row R1-R5 looked up in step 7.10. In step 7.16 the observer controller 102F attempts to detect, within a time period Tmn read step 7.10 from the selected row R1-R5, an additional or repeated signal or message with the same content received in the most recent reception in step 7.02; when no repeated transmission of the signal or message of the most recent execution of step 7.02 detected within this selected monitor period of time Tmn of selected row R1-R5, the observer controller 102F proceeds back to an additional execution of step 7.02.

In the alternative, when a second signal or message content MSG2 1 is received in step 7.16 within the period of time Tmn, the observer controller 102F proceeds on to step 7.18 stores the second time of reception T2 and the received second signal energy intensity Er2 of the second signal or message content MSG2 in the observer memory 102I. The observer controller then proceeds from step 7.18 on to execute step 7.20.

In step 7.20 observer controller next compares a minimum signal energy intensity level criteria Enmin with the second energy level intensity Er2 of the second message of interest MSG2, wherein Enmin as accessed in the row R1-R5 selected in step 7.10. When the received second energy intensity Er is less than the Enmin selected from the selected row R1-R5, then the observer controller directs the observer 102 to proceed in to on from step 7.20 to step 7.22 and nullify the signal/message values of MSG1 & MSG2 as stored in the observer memory 102I.

In the alternative, when the observer controller determines in step 7.20 that the received energy intensity level Er2 is greater or equal to the minimum required energy intensity level Enmin, the observer 102 proceeds onto step 7.24 and accesses the values of the row R1-R5 looked up in step 7.10.

In step 7.24 the observer controller reads a preset speed indication parameter Sn for the row R1-R5 selected in step 7.10. The observer controller then calculates the delta in Er2−Er1 and divides the resultant ΔE by the time that has elapsed between the second message receipt T2 and the first message receipt T1, or ΔT. The ΔE/ΔT is an indication of the speed of the signal/message emitter, i.e. the beacon 118 or another signal emitter, such as an AirTag™. The speed indication parameter Sn is previously derived stored as an indication of an actual speed above which would indicate that the carrier is going faster than the observer 102 is programmed to act on. If the resultant of ΔE/ΔT not less than Sn, then the observer controller proceeds on to step 7.22. In the alternative, if the value of ΔE/ΔT is less than Sn, then the observer controller proceeds on to step 7.26. In step 7.26 the observer controller queries the selected row R1-R5 to determine if a NAME specific warning module 102E-102E is to be energized, and if so, the observer controller proceeds to energize the indicated warning module 102B-102E in step 7.28. The observer 102 then proceeds from step 7.26 or step 7.28 to step 7.30 and to energizes the main warning module 102A.

In step 7.32 the observer controller initially sets a adjusts a counter value V1 to a energizing time value Tcn read from the row R1-R5 accessed in step 7.10. The observer controller and then adjusts the counter value further towards a null value in every additional execution of step 7.34. The Tcn is read from the row R1-R5 selected is step 7.10. After each execution of step 7.34, the observer controller determines in step 7.36 if an alternate signal/message has been received that has a third message content MSG3 which doesn't match the first message content MSG1; if not, the observer controller proceeds on to execute step 7.38. In step 7.38 the observer controller determines if the counter value V1 has reached a row null value Vn, wherein the row null value is read from the row R1-R5 selected in step 7.10. If the counter value V1 has not reached the null value Vn in step 7.38, the observer controller proceeds back to and additional execution of step 7.34. When the counter value V1 has reached the null value Vn in step 7.38, the observer controller proceeds to step 7.40 de-energize the warning modules 102A of step 7.26 and any additional warning modules 102B-102E energized in step 7.28.

In an alternate result of step 7.36, when the observer controller determines in step 7.36 that an alternate signal/message has been received that has a third message content MSG3 which doesn't match the first message content MSG1, the observer controller proceeds on the step 8.00 to perform a program flow that optionally operates in parallel to the flowchart of FIG. 7.

FIG. 8 is a flowchart of the operation of the observer 102 in determining if a second non-matching beacon signal is detected while the first detected beacon is being managed in the process of FIG. 7. When the observer controller 102F determines in step 7.36 that a third message content MSG3 of another wireless communication, e.g., a BLE beacon message or an AirTag signal, has been detected in step 7.36, the observer controller 102F in step 8.00 records the third message content MSG3, a third time if T3 of receipt of the message, and the level of the third received energy intensity level Er3 of the third message content MSG3 in the observer memory 102I, and next moves on to step 8.02 and to query the received third message content MSG3 for a NAME. If no NAME is read from the message in step 8.02, the observer controller 102F in step 8.04 reads a set of default values of a default row R5 from a default value row R5 lookup table 102K of FIG. 9; in the alternative if the observer controller 102F has read a NAME from the third message detected in step 8.02, the observer controller 102F proceeds in step 8.04 to access a lookup access row Rn associated with the NAME from the lookup table 102K of FIG. 9, wherein “n” represents an identifying number of either one of the NAME rows R1-R4 or the default row R5

The observer controller 102F in step 8.08 next compares a minimum signal energy intensity level criteria Enmin of row Rn with the third energy level intensity Er3 of the message of interest, wherein Enmin as accessed in the row Rn selected in step 8.06. When the third received energy intensity Er3 is less than the Enmin selected from the selected row Rn, then the observer controller 102F directs the observer controller 102F to proceed to step 7.38

In step 8.10 the 108F monitors for a new time monitoring period Tmn for a receipt of a fourth message content, and returns to step 7.36 if no additional message content matching the third message content MSG3 within that time monitoring period Tmn. It is understood that this time monitoring period Tmn is selected from the Row Rn selected in step 8.06. When a fourth message content MSG4 is received in step 8.10 that matches the third message content MSG, the observer controller 102F in step 8.12 next compares the minimum signal energy intensity level criteria Enmin with the fourth energy level intensity Er4 of the message of interest, wherein Enmin as accessed in the row R1-R5 selected in step 8.06. When the fourth received energy intensity Er4 is less than the Enmin selected from the selected row R1-R5 of step 8.06, the observer controller 102F directs the observer controller 102F to proceed from step 8.12 to step 7.38. In the alternative, when the fourth received energy intensity Er4 is greater than the Enmin selected from the selected row R1-R5 of step 8.06, the observer controller 102F directs the observer controller 102F to proceed from step 8.14.

The observer controller then calculates in step 8.14 a second delta ΔE2 by subtraction of Er3 from Er4, and divides the resultant ΔE by the time that has elapsed between the third message receipt T3 and the first message receipt T4, or ΔT2. The ΔE2/ΔT2 is an indication of the speed of the signal/message emitter, i.e. the beacon 118 or another signal emitter, such as an AirTag™. The speed indication parameter Sn is previously derived and stored as an indication of an actual speed which would indicate that the carrier is going faster than the observer 102 is programmed to act upon. If the resultant of ΔE2/ΔT2 is not less than Sn, then the observer controller returns to step 7.36. In the alternative, if the value of ΔE/ΔT is less than Sn, then the observer controller proceeds on from step 8.14 to step 8.16.

In step 8.16 the observer controller queries the selected row R1-R5 to determine if a NAME specific warning module 102E-102E is to be energized, and if so, the observer controller proceeds to energize the indicated warning module 102B-102E in step 8.18. The observer 102 then proceeds from step 8.16 or step 8.18 to step 8.20. In step 8.20 the observer controller 102F whether the warning time value Tcn of the row Rn is greater than the current counter value CTR. When the warning time value Tcn of the row Rn is greater than the current counter value CTR, the observer controller 102F resets the counter CTR to the energize time value Tcn in step

FIG. 9 is the Observer's Look up Table accessed at steps 7.10, 7.16, 7.26, 8.10 & 8.14., having counter values and maximum energy change by Name within a duty cycle, length of illumination time and which module per Name.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. A system for providing approaching carrier warnings, the system comprising:
a beacon coupled with said carrier traveling on a pathway, the beacon comprising an encoded identification signal, and a wireless signal emitter coupled with a beacon power source, the signal emitter broadcasting the identification signal; and
an observer installed proximate to a line-of-sight obstruction on the pathway, the observer comprising a signal light electrically coupled with a power source via a controllable on/off switch, and the power source is further electrically coupled with and provides electrical power to the a signal sensor, a source of encoded instructions (a memory”), and a logic device, the logic device communicatively coupled with the memory and the controllable switch, the encoded instructions directing the logic device to:
(a.) deriving a speed by comparing separate signal energy levels a pair of information signals received from the beacon, and a delta of time of reception of the pair of information signals;
(b.) determine whether the beacon is moving no faster than a predetermined speed parameter by a magnitude of difference of the energy signals divided by the delta of time of reception;
(c.) when the logic device determines that speed is no faster than the predetermined speed parameter, electrically powering illumination of the signal light for a preset duration by directing the on/off switch to enable an electrical current to flow from the power source and to the signal light; and
(d.) when the signal light has been illuminated for the preset direction, return the observer to a rest state, whereby an electrical power flow through the controllable switch and the power source to the signal light is inhibited.

2. The system of claim 1, the signal emitter and the signal sensor are selected to enable detection of the identification signal by the signal sensor at no more than 8 meters.

3. The system of claim 1, wherein the carrier is selected from the group of carriers consisting of a person, an animal, a vehicle, a bicycle, a motorized bicycle, an automobile, and a truck.

4. The system of claim 1, wherein the beacon is detachably coupled to the carrier.

5. The system of claim 1, wherein the beacon is comprised within a portable electronic device.

6. The system of claim 1, wherein the portable electronic device is acellular phone or other portable computational device.

7. The system of claim 1, further comprising a second beacon coupled with a second carrier, wherein the second beacon emits a second identification signal distinguishable from the earlier received identification signal, and the observer detects the second identification signal, and thereupon the observer reinitiates an illumination duration, whereby the period of time of illumination of the signal light is reset.

8. The system of claim 5, wherein the instructions are additionally configured to direct the processor to illuminate the signal light for an alternate period of time when the second signal is detected by the signal sensor.

9. The system of claim 1, wherein the signal light comprises a light-emitting diode (LED).

10. The system of claim 1, wherein the observer is positioned proximate to the pathway.

11. The system of claim 1, wherein the observer power source is selected from the group of power sources consisting of a rechargeable battery, replaceable battery, a solar power cell, and a connection to a power grid.

12. The system of claim 1, the beacon further comprises an enable/disable control coupled with the wireless signal emitter and the beacon power source, and when the enable/disable control is set to enable by a user the signal emitter receives electrical power from the beacon power source and thereupon broadcasts the identification signal.

13. The system of claim 12, wherein the beacon further comprises a countdown timer coupled with the enable/disable control and the beacon power source, and the countdown timer is initiated when the enable/disable control is set to enable, and the enable/disable control is set to disable when the countdown timer times out, whereby the signal emitter ceases broadcasting the identification signal.

14. The system of claim 1, wherein the line-of-sight obstruction is selected from the group of visual obstructions consisting of a bend in the pathway, a decrease in elevation of the pathway, an increase and subsequent decline of the pathway, vegetation, a sign, a bridge crossing over the pathway, a volume of atmospheric fog, a volume of atmospheric smog, and a geologic feature.

15. A method for providing road safety warning signals, the method comprising:
installing proximate to a blind curve a roadside signaling device which emits a signaling light when the device detects proximity of a beacon and continues to emit the signaling light for a preset duration of time there after; and
equipping one or more slow-moving vehicles which traverse the blind curve with instances of the detectable beacon.

16. The system of claim 1 further comprising:
the identification signal includes a name datum identifying a type of carrier;
a plurality of identifying lights, each light of the plurality of lights visually rendering a unique and visually distinguishable icon when powered, wherein the encoded instructions are additionally configured to direct the processor to associate each identifying light with at least one name datum, and enable power delivery to illuminate the associated identifying light that is associated with the identification signal type datum.

17. A system for providing approaching carrier warnings, the system comprising:
a beacon carried by an carrier traveling on a pathway, the beacon comprising a wireless signal emitter coupled with a beacon power source, the signal emitter broadcasting an identification signal; and
an observer installed proximate to a line-of-site obstruction on the pathway, the device comprising signal light coupled with a power source via a controllable switch, and the power source is electrically coupled with and provides electrical power to a signal sensor and a logic, and the logic is communicatively coupled with the controllable switch, wherein the logic is configured to:
(a.) disable an electrical power connection through the controllable switch and between the power source the signal light when the device is in a rest state; and
(b.) alternately enable the electrical power connection through the controllable switch between the power source and the signal light for a preset duration when the sensor indicates that the identification signal is detected, whereby the signal light is illuminated for a predetermined period of time.

18. A method for providing road safety warning signals, the method comprising:
installing proximate to a blind curve a roadside signaling device which emits a signaling light when the device detects receipt of an identification signal a beacon and continues to emit the signaling light for a preset duration of time thereafter; and
equipping one or more slow-moving vehicles which traverse the blind curve with instances of the detectable beacon.

19. The method of claim 18, wherein the beacon transmits a name of the beacon to the roadside signaling device.

20. The method of claim 19, further comprising;
the roadside signaling device is configured to determine a speed of the beacon in derivation from two succeeding identification signals, wherein the delta in energy levels of the two succeeding identification signals and the time delta of reception of the two succeeding identification signals; and
if and only if the determined speed if the beacon is less than or equal to a preset speed, empowering the signaling device to emits the signaling light preset duration of time.
